(19) United States
(12) Patent Application Publication
(10) Pub. No.: US 2011/0179235 A1
(43) Pub. Date: Jul. 21, 2011

(54) DRIVING DEVICE AND METHOD OF ACCESSING DATA BY USING THE SAME

(75) Inventors: Chien-Fang LEE, Taipei (TW); Liang-Chun Lin, Taipei (TW)

(73) Assignee: Prolific Technology Inc., Taipei (TW)

(21) Appl. No.: 13/010,133

(22) Filed: Jan. 20, 2011

(30) Foreign Application Priority Data
Jan. 20, 2010 (TW) 099101556

(51) Int. Cl. G06F 12/00

(52) U.S. Cl. 711/154; 711/E12.001

(57) ABSTRACT

A driving device and a method of accessing data are provided. The driving device includes a bridge and a driver. The bridge includes a first controller. The driver includes a storage unit and a second controller. The first controller is for outputting a command according to an operating event. The second controller is for obtaining a corresponding data from the storage unit according to the command and uploading the data to the first controller.

This application claims the benefit of Taiwan application Serial No. 99101556, filed Jan. 20, 2010, the subject matter of which is incorporated herein by reference.

### BACKGROUND OF THE INVENTION

1. Field of the Invention

The invention relates in general to a driving device and a method of accessing data by using the same, and more particularly to a cost-down driving device and a method of accessing data by using the same.

2. Description of the Related Art

With the rapid advance in technology, computer has become an indispensible electronic product to modern people in their everydayness. Data is transmitted between computer and data storage device through a driving device. The driving device includes a bridge and a driver, wherein the computer transmits data to the data storage device through the bridge, and the driver drives the data storage device such as an optical disk drive (ODD) or a hard disk drive (HDD).

When a computer is linked to a data storage device through a driving device, the computer will send a request for obtaining the embedded data relevant to the driving device and the data storage device through the driving device. The embedded data of the driving device is obtained by the storage unit of the bridge and the storage unit of the driver. Examples of the embedded data include manufacturer name, product model or relevant firmware. The storage unit is such as a non-volatile memory. However, in order to store the corresponding embedded data, the bridge and the driver are respectively equipped with a storage unit, not only occupying more space of the circuit board but also incurring additional cost for the circuit board and the storage unit.

### SUMMARY OF THE INVENTION

The invention is directed to a driving device and a method for accessing data by using the same. A single storage unit is used by the bridge and the driver to save the space and reduce the cost for circuit board. Since only one single storage unit is used, the cost for the storage unit is reduced, and the flexibility in hardware design is increased.

According to a first aspect of the present invention, a driving device including a bridge and a driver is provided. The bridge includes a first controller. The driver includes a storage unit and a second controller. The first controller is for outputting a command according to an operating event. The second controller is for obtaining a corresponding data from the storage unit according to the command and uploading the data to the first controller.

According to a second aspect of the present invention, a method for accessing data used in a driving device is provided. The driving device includes a bridge, and has a driver with a storage unit. The method includes the following steps. Firstly, the bridge outputs a first command according to an operating event. Next, the driver obtains a corresponding data from the storage unit according to command and uploads the data to the bridge.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a driving device used in a storage system according to an embodiment of the invention;

FIG. 2 shows a block diagram of the driving device of FIG. 1; and

FIG. 3 shows a flowchart of a method for accessing data used in the driving device of FIG. 2.

### DETAILED DESCRIPTION OF THE INVENTION

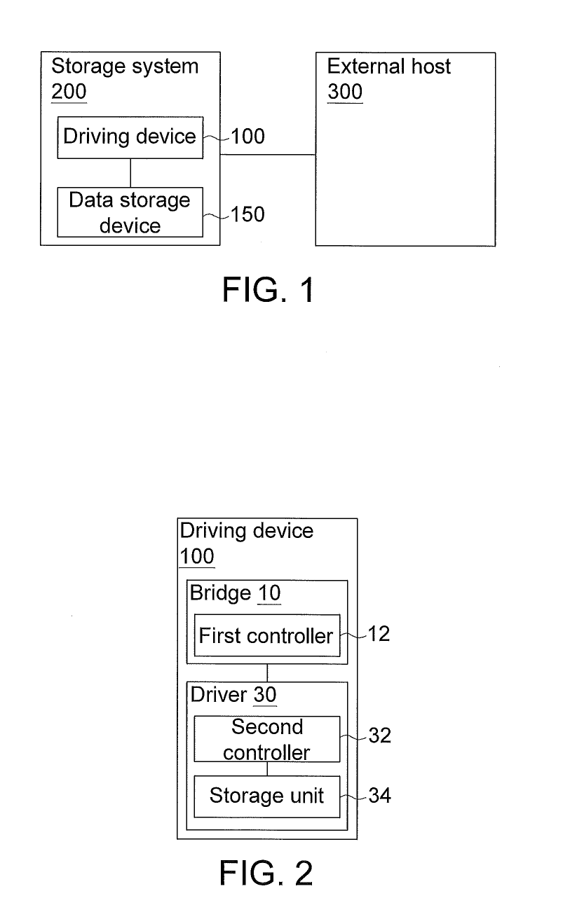

An embodiment in which a driving device is used in a storage system is disclosed below. Referring to FIG. 1, a driving device 100 used in a storage system 200 according to an embodiment of the invention is shown. As indicated in FIG. 1, the storage system 200 includes a data storage device 150 and a driving device 100. Through the driving device 100, the external host 300 accesses the data stored in the data storage device 150 or stores other data to the data storage device 150. The external host 300 is such as a desktop computer, a portable computer or a device which can be linked to a storage system. The data storage device 150 is such as an optical disk drive (ODD) or a hard disk drive (HDD).

Referring to FIG. 2, a block diagram of the driving device 100 of FIG. 1 is shown. The driving device 100 includes a bridge 10 and a driver 30. The bridge 10 includes a first controller 12. The driver 30 includes a second controller 32 and a storage unit 34. The first controller 12 is for outputting a command according to an operating event. The second controller 32 is for obtaining a corresponding data from the storage unit 34 according to the command and uploading the data to the first controller 12.

Also referring to FIG. 1, the first controller 12 uploads the data to the external host 300 when the data needs to be uploaded to an external host 300 coupled to the bridge 10. The data is reserved to the bridge 10 when the data does not need to be uploaded to the external host 300 coupled to the bridge 10. The driver 30 is coupled to data storage device 150 for accessing the data storage device 150.

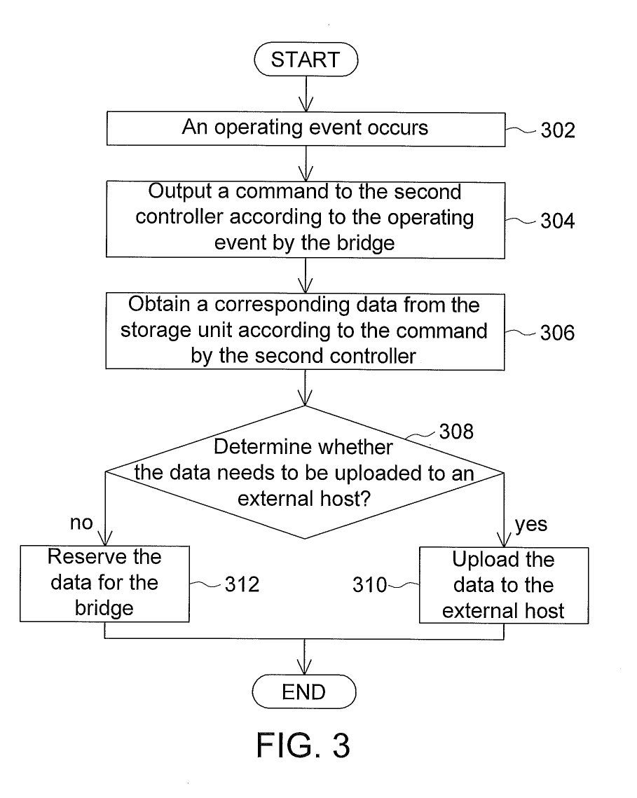

Referring to FIG. 3, a flowchart of a method for accessing data used in the driving device 100 of FIG. 2. Firstly, the method begins at step 302, an operating event occurs. For example, the operating event occurs when the storage system 200 and the external host 300 receive electrical power and when the driving device 100 is coupled to the external host 300. Next, the method proceeds to step 304, the bridge 10 outputs a command to the second controller 32 according to the operating event. The command is such as a request that the bridge 10 is required to obtain a data.

Then, the method proceeds to step 306, the second controller 32 obtains a corresponding data from the storage unit 34 according to the command. For example, the corresponding data corresponds to a data of the command mentioned above.

Next, the method proceeds to step 308, whether the data needs to be uploaded to an external host is determined: if so, the method proceeds to step 310; otherwise, the method proceeds to step 312. The determination step can be performed by the second controller 32 of the driver 30 or by the first controller 12 of the bridge 10.

Then, the method proceeds to step 310, the data is uploaded to the external host 300. In step 312, the data is reserved for the bridge 10.

For example, provided that the bridge 10 is coupled to the external host 300. If the command is for that the external host 300 requests the storage system 200 to provide relevant data, then the data will be determined as the data that needs to be uploaded to the external host 300, otherwise, the data may be determined as the data to be used by the bridge 10 and is thus reserved for the bridge 10.

The said relevant data that the external host 300 requests the storage system 200 to provide is such as an embedded data. Examples of the embedded data include the driver manufacturer name, the data storage device manufacturer name, the product serial number, relevant firmware and timing information, or the data indicating that the data storage device 150 is an optical disk drive or a hard disk drive. However, the said data is not limited to embedded data, and other types of data would also do.

In addition, the bridge 10 and the driver 30 can further be combined in an integrated circuit (IC), not only saving the space for the circuit board but also expanding the fields of application. The bridge 10 supports universal serial bus (USB) interface. The driver 30 supports the specifications such as integrated drive eelectronics (IDE) bus, serial advanced technology attachment (SATA), or personal computer interface (PCI).

The driving device and the method of accessing data by using the same disclosed in the disclosure reduce cost and save space for the circuit board. Since the space is saved, the cost is further reduced. Thus, the product using the driving device and the method of accessing data disclosed not only reduce cost and save product volume, but also increase the flexibility in hardware design and enhances market competiveness.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A driving device, comprising:
a bridge, comprising:
a first controller for outputting a command according to an operating event; and
a driver, comprising:
a storage unit; and
a second controller for obtaining a corresponding data from the storage unit according to the command and uploading the data to the first controller.

2. The device according to claim 1, wherein the first controller uploads the data to the external host when the data needs to be uploaded to an external host coupled to the bridge.

3. The device according to claim 1, wherein the driver is for being coupled to a data storage device and for accessing the data storage device.

4. The device according to claim 3, wherein the data storage device is an optical disk drive (ODD) or a hard disk drive (HDD).

5. The device according to claim 1, wherein the data is reserved for the bridge when the data does not need to be uploaded to an external host coupled to the bridge.

6. A method for accessing data used in a driving device, the driving device including a bridge and a driver with a storage unit, and the method comprising:
outputting a command according to an operating event by the bridge; and
obtaining a corresponding data from the storage unit according to the command and uploading the data to the bridge by the driver.

7. The method according to claim 6, further comprising:
uploading the data to the external host by the bridge when the data needs to be uploaded to an external host coupled to the bridge.

8. The method according to claim 6, wherein the driver is for being coupled to a data storage device and for accessing the data storage device.

9. The method according to claim 8, wherein the data storage device is an optical disk drive (ODD) or a hard disk drive (HDD).

10. The method according to claim 6, further comprising:
reserving the data for the bridge when the data does not need to be uploaded to an external host coupled to the bridge.
